(19) United States
(12) Patent Application Publication
(10) Pub. No.: US 2018/0128928 A1
(43) Pub. Date: May 10, 2018

(54) ACCELEROMETRIC SENSOR FOR SEISMIC MONITORING OF STRUCTURES

(71) Applicant: AREA PREFABBRICATI S.P.A., Casalgrande (RE) (IT)

(72) Inventor: Emanuel MANFREDINI, Casalgrande (RE) (IT)

(21) Appl. No.: 15/577,746

(22) PCT Filed: May 27, 2016
(86) PCT No.: PCT/IB2016/053134

§ 371 Date: Nov. 28, 2017

(30) Foreign Application Priority Data
May 28, 2015 (IT) 102015000019006

(51) Int. Cl. G01V 1/16; G01V 1/22; G01V 1/36; G01V 1/18

(52) U.S. Cl. CPC G01V 1/164; G01V 1/22; G01P 21/00; G01V 1/18; G01V 1/362

(57) ABSTRACT

The invention falls within the field of the techniques for manufacturing seismic monitoring systems and is applicable to structures related to civil engineering. The accelerometric sensor comprises
one or more accelerometers (2a, 2b);
a main microprocessor (7);
a control microprocessor (8);
a temperature sensor (3);
a CAN bus driver (4);
two connectors (5), one input and one output, of a CAN bus line;
an input clock circuit (11);
an error signaling circuit (10);
a power supply unit (9);
a container element (12), which at its interior contains the above components.

Seismic monitoring systems are used in the art, installed at structures such as bridges and buildings. Most of these monitoring systems use accelerometers, which measure the accelerations of the structure points at which they are installed. Accelerometers are connected, wired or wirelessly, to an acquisition unit that receives data from the accelerometers and processes them. Usually, the accelerometers transmit analog signals to the acquisition unit; the acquisition unit then converts the analog signals into digital data. Moreover, the acquisition unit processes these digital data according to procedures and with objectives that vary depending on the monitoring systems used for the seismic monitoring of the structures.

Several types of accelerometers are known in the art to be used for the seismic monitoring of the structures. Capacitive accelerometers and piezoelectric accelerometers, etc., may be mentioned among these types.

MEMS (Micro Electro-Mechanical Systems) accelerometers are known. It is noted that MEMS include mechanical and electrical microsystems, integrated on the same base material; the electrical and mechanical microsystems are made in miniature form.

A very important aspect in the design and construction of a seismic monitoring system is to determine the data transmission modes from the accelerometers to the acquisition unit. Since sampling rates are high, the data transmission in wireless mode does not usually reach the required reliability levels due to the interferences that may be caused by a variety of causes.

However, it should be noted that wired data transmission is affected by the fact that, since they usually are analog signals, the transmitted signal can fade significantly with an increasing cable length and is also disturbed by the background noise due to the cable itself.

Therefore, the maximum acceptable length of the connecting cables between accelerometers and acquisition units, in some cases, may have a limited value; this impacts negatively on the seismic monitoring system design.

Moreover, the accelerometers that transmit analog signals to the acquisition unit are connected according to star layouts to the acquisition unit, so that each accelerometer is connected directly to and independently of the other accelerometers to the acquisition unit itself.

In order to have reliable data it is essential, inter alia, to use accelerometers whose features remain constant over time and which are influenced, as little as possible, by thermal phenomena; in any case, the influence of thermal phenomena must be such as not to alter the measures by amounts exceeding the acceptable variations for monitoring the structure in question. Usually, the accelerometers that meet these requirements are very expensive and, moreover, referring only to the “initial setup” of the accelerometers themselves (when they are installed), at least conceptually they do not have the reliability of instruments whose measures, during their working life, depending on the conditions and in particular depending on the temperature at which said instruments work, are automatically corrected (compensated) as a function of the actual conditions, and in particular as a function of the temperature at which these instruments work.

The object of the present invention is to provide an accelerometric sensor which overcomes the drawbacks mentioned above by carrying out the digitalization of the analog signals immediately downstream of the accelerometer, so as to have signals with low noise levels, even in the presence of sufficiently long cables.

Another object of the present invention is to provide an accelerometric sensor that can be connected to the acquisition unit also via a serial link, so as to be able to connect various accelerometric sensors on a single cable connecting said accelerometric sensors to the acquisition unit.

A further object of the present invention is to provide an accelerometric sensor comprising accelerometers that are periodically automatically checked by components internal to the accelerometric sensor itself.

A further object of the present invention is to automatically compensate at the generic instant “t” the measures of the accelerometers included in the accelerometric sensor as a function of the temperature at which the accelerometric sensor itself at the same instant t is working.

This and other objects are achieved by the accelerometric sensor for the seismic monitoring of structures object of the present invention. The features and the advantages of the present invention will become more apparent from the following description of an embodiment thereof, given by way of non-limiting example in the accompanying drawings, in which:

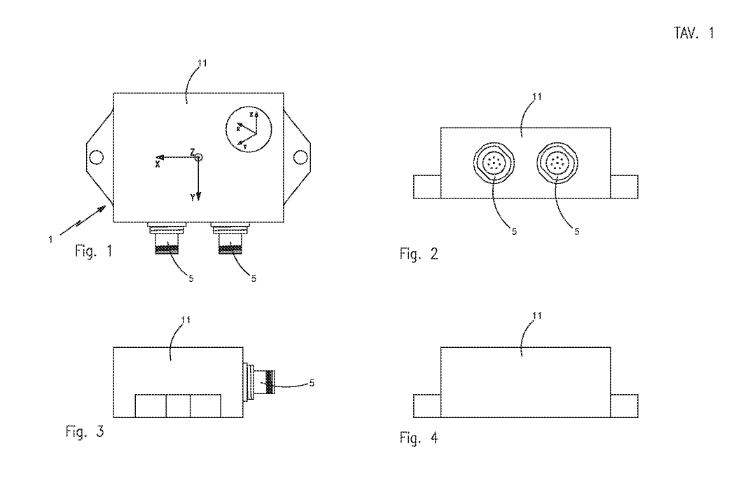

FIG. 1 shows a top plan view of an accelerometric sensor obtained according to the present invention;

FIG. 2 shows, in the same scale of FIG. 1, a front perspective view of the accelerometric sensor in FIG. 1;

FIG. 3 shows, in the same scale of FIG. 1, a lateral perspective view of the accelerometric sensor in FIG. 1;

FIG. 4 shows, in the same scale of FIG. 1, a rear perspective view of the accelerometric sensor in FIG. 1;

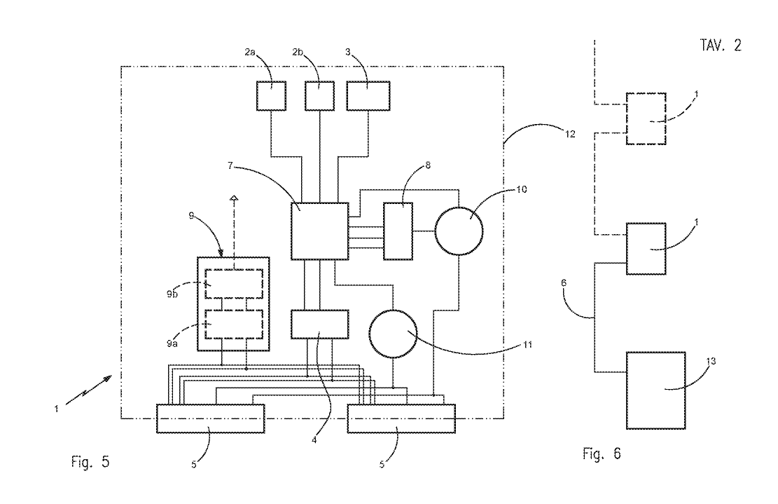

FIG. 5 shows the block diagram of the aforesaid accelerometric sensor where the main components of the accelerometric sensor are represented;

FIG. 6 shows one part of a circuit diagram for the connection between accelerometric sensors and the respective acquisition unit.

Referring to FIGS. 1, 2, 3, 4, 5 and 6, the accelerometric sensor 1 obtained according to the present invention is described, according to an embodiment thereof. The accelerometric sensor 1, along with other accelerometric sensors equivalent to the above accelerometric sensor 1 and at least one acquisition unit 13, is part of a seismic monitoring system installed on a structure consisting, for example, of reinforced concrete beams, pillars and horizontal elements.

The accelerometric sensor 1 comprises two accelerometers 2a, 2b, a main microprocessor 7, a control microprocessor 8, a temperature sensor 3 which measures the temperature inside the accelerometric sensor 1, a CAN bus driver 4 (CAN stands for: Controller Area Network), two connectors 5 (one input and one output), a power supply unit 9, an error signaling circuit 10, an input clock circuit 11 and a container element 12 which at its interior contains the above-reported components. Within said container element 12, a synthetic filling resin is also present which makes all the components present inside the container element 12 itself a single “solid” element.

The two accelerometers 2a, 2b, the temperature sensor 3, the input clock circuit 11 and the CAN bus driver 4 are connected to the main microprocessor 7.

The control microprocessor 8 is connected to the main microprocessor 7 and to the error signaling circuit 10.

The power supply unit 9 is connected to all the above components of the accelerometric sensor 1 to which it provides the necessary electric power.

The two accelerometers 2a and 2b are of tri-axial type; therefore, they measure the acceleration by providing the three components of the acceleration referred on three predetermined mutually orthogonal Cartesian axes. The two accelerometers 2a, 2b, which are equivalent to each other, are manufactured using the MEMS technology. The main microprocessor (7), in a generic time interval, considers the analog signals transmitted by the accelerometers 2a, 2b or by one of the two the accelerometers 2a, 2b; the main microprocessor 7 samples said analog signals with a predetermined frequency, in the instants indicated by the acquisition unit 13, and converts them into digital data; the main microprocessor 7, in addition, processes such digital data. The processing of the digital data, carried out by the main microprocessor 7, also comprises the correction (compensation) of the measurements of the accelerometers 2a, 2b as a function of the temperature of the accelerometric sensor 1 upon measurement. The main microprocessor 7 then sends such data to the acquisition unit 13 by means of a CAN bus line. It is noted that the main microprocessor 7 sends the data over the CAN bus network by means of the CAN bus driver 4; it is noted that the accelerometric sensor 1 is connected to a CAN bus line.

The main microprocessor 7, in addition, with predetermined frequency controls the functioning of the accelerometers 2a, 2b and activates and executes the control procedures of the status of the software residing in the accelerometric sensor 1, used in the accelerometric sensor 1 itself.

According to a possible embodiment variant, the main microprocessor 7 also controls other components that are part of the accelerometric sensor 1.

In relation to the above correction (compensation) of the measures of accelerometers 2a, 2b as a function of temperature, it is noted that during the calibration of the accelerometric sensor 1, parameters were set which allow correcting the accelerations values measured as a function of the temperature at which the accelerometric sensor 1 itself works, so as to determine accelerations values “not affected” by errors due to temperature. It is noted that the above parameters are obtained on the basis of the calibration curves of the accelerometric sensor 1 obtained for various temperatures.

In relation with the periodic control of accelerometers 2a, 2b carried out by the main microprocessor 7, the following is noted.

Each of the two accelerometers 2a, 2b is provided with an internal control micro-vibrator which can be turned on and off by the main microprocessor 7. The main microprocessor 7, in order to control the correct functioning of each of said one or more accelerometers 2a, 2b, periodically activates the internal control micro-vibrator of each of the two accelerometers 2a, 2b and compares the value of the acceleration, due to the micro-vibrator itself, measured by said accelerometer 2a, 2b, with the exact value (known before hand) of the acceleration induced by said micro-vibrator. For example, suppose that the main microprocessor 7, at instant t, controls the functioning of accelerometer 2a; the main microprocessor 7 activates the micro-vibrator (mentioned above) of accelerometer 2a and measures the acceleration by measuring the three components referred to the measurement axes (x, y, z); the main microprocessor 7 then compares the acceleration measured by accelerometer 2a with the exact value (known before hand) of the acceleration (induced by said micro-vibrator).

It is noted that the exact value “known before hand” mentioned above usually is a data obtained upon manufacturing the accelerometric sensor 1.

It is also possible that such a value “known before hand” is obtained upon the installation of the seismic monitoring system of which the accelerometric sensor 1 is part. In this case, once the accelerometric sensor 1 has been installed and connected to the acquisition unit 13, the main microprocessor 7 activates the above micro-vibrator and accelerometer 2a (considered) carries out the measurement of the acceleration and stores it as “exact value”.

Similar operations are carried out by the main microprocessor 7 in relation to the other accelerometer 2b.

The control procedures carried out by the main microprocessor 7 also include the implementation of a CRC (cyclic redundancy check) procedure which, with a predetermined frequency, checks the status of the software used in the accelerometric sensor 1.

In the case of the accelerometric sensor 1, according to a first measurement strategy, the two accelerometers 2a, 2b, which are equivalent to each other, carry out different and interchangeable roles; one of the two accelerometers (such as accelerometer 2a) is now identified as the reference accelerometer and is therefore the accelerometer whose measurements are considered, processed and transmitted by the main microprocessor 7 to the acquisition unit 13 connected to the accelerometric sensor 1. Accelerometer 2b is identified as the reserve accelerometer and measures, which it still maintains, are not taken into account until the reference accelerometer 2a is working perfectly, as better described hereinafter.

According to a possible embodiment variant, accelerometers 2a and 2b periodically exchange the reference accelerometer and reserve accelerometer roles.

In the case of malfunctioning of the reference accelerometer (accelerometer 2a in the example), occurred during the operating life of the accelerometric sensor 1, the main microprocessor 7, which controls with predetermined frequency the functioning of the reference accelerometer, disconnects the reference accelerometer itself (accelerometer 2a in the example), signaling the malfunctioning of the reference accelerometer 2a to the acquisition unit 13 (to which the accelerometric sensor 1 is connected) and connects the reserve accelerometer (accelerometer 2b in the example) which now begins to perform the role of reference accelerometer.

It is noted that, while the main microprocessor 7 controls (by activating said micro-vibrator internal to accelerometer 2a) the functioning of accelerometer 2a itself, the main microprocessor 7 takes under consideration and processes the measurements carried out by the reserve accelerometer 2b.

The accelerometric sensor 1 is connected to the acquisition unit 13 and usually to other accelerometric sensors (equivalent to the accelerometric sensor 1) by means of data transmission lines which comprise a CAN bus line for the transmission of the data measured by the accelerometric sensor 1, a synchronization line which is a specific line by means of which the instants are indicated, by the acquisition unit 13, in which the accelerometric sensor 1 must carry out the acceleration measurements and an error signal transmission line which is a specific line for the transmission of the malfunctioning messages; the accelerometric sensor 1 is connected to the acquisition unit 13 also by means of an electrical line by means of which the acquisition unit 13 power supplies the accelerometric sensor 1 itself.

All these lines pass by cable 6 which connects the accelerometric sensor 1 and the acquisition unit 13.

It is noted that the acquisition unit 13 indicates the instants at which the accelerometric sensor 1 must carry out the measurements to the accelerometric sensor 1 itself. The acquisition unit 13 therefore has also the function of clock generator of said monitoring system which includes (at least) the accelerometric sensor 1, a plurality of additional accelerometric sensors, equivalent to the accelerometric sensor 1 itself, and the acquisition unit 13 itself. The clock signal transmitted by the acquisition unit 13 is received by the accelerometric sensor 1 and, in particular, by the main microprocessor 7 by means of the clock input circuit 11. The control microprocessor 8, which has less memory capacity than that of the main microprocessor 7, constantly checks if the main microprocessor 7 is properly functioning.

More precisely, the main microprocessor 7 and the control microprocessor 8 exchange signals that substantially allow them to mutually control the timing and the mode of reaction of both the main microprocessor 7 and of the control microprocessor 8.

If an anomaly occurs in the signals (data) exchanged between the main microprocessor 7 and the control microprocessor 8, the main microprocessor 7 and/or the control microprocessor 8 no longer function correctly. Consequently, the error signaling circuit 10 transmits, to the acquisition unit 13, an out-of-service message for the accelerometric sensor 1. For the transmission of an out-of-service message for the accelerometric sensor 1, the error signaling circuit 10 uses a specific data transmission line. The accelerometric sensor 1 is then excluded from the CAN bus network waiting to be replaced (or possibly even repaired).

The power supply unit 9 comprises two stages. The first stage 9a, which significantly reduces the direct current voltage is of switching type. The second stage 9b further reduces the voltage to power supply the components of the accelerometric sensor 1. The second stage 9b is of linear type.

It is noted that the accelerometric sensor 1 measures the acceleration by providing the three acceleration components according to a predetermined coordinate system of orthogonal Cartesian axes x′, y′, z′ different from the coordinate system of orthogonal Cartesian axes x, y, z along which the accelerometers 2a, 2b measure the acceleration itself; axes x, y, z are also called “measurement axes.” The parameters which allow the accelerometric sensor 1 to carry out the measurement of the accelerations with respect to the coordinate system of orthogonal Cartesian axes x′, y′, z′ are established, at the time of installation of the seismic monitoring system which includes the accelerometric sensor 1, during the operations of setting the accelerometric sensor 1, once the orientation of the implemented accelerometric sensor 1 has been detected.

The fact that the accelerometric sensor 1 can carry out the measurement of the accelerations with respect to a coordinate system of orthogonal Cartesian axes x′, y′, z′ different from the measurement axes x, y, z allows, among other things, to make the operations of positioning and fixing (and thereby of installation) of the accelerometric sensor 1 itself to the structure to be monitored more rapid. In fact, the accelerometric sensor 1 can be installed on the structure to be monitored without the need to match the measurement axes (x, y, z) with the axes with respect to which the acceleration components (x′, y′, z′) are to be known. During the setting operations of the accelerometric sensor 1, in fact, knowing the actual orientation of the measurement axes (x, y, z) and knowing the axes (x′, y′, z′) with respect to which the acceleration components are to be known, the necessary parameters are set on the acquisition unit 13 by which the accelerometric sensor 1 itself provides the values of the accelerations related to axes x′, y′, z′.

The direction and the orientation of the measurement axes x, y, z are indicated on the container element 12 of the accelerometric sensor 1; it is noted that the two accelerometers 2a, 2b, upon the implementation of the accelerometric sensor 1, are positioned in a very accurate manner, according to the design geometry of the accelerometric sensor 1 itself; moreover, the dimensional tolerances of the container element 12 are such as to ensure, with a known tolerance, the correspondence, in terms of direction (and orientation) between the measurement axes and the representation of such axes indicated on the container element 12 itself.

The container element 12 is provided with seats and/or references for the temporary coupling (at predetermined positions) with an implementation tool that, during the installation steps of the accelerometric sensor 1, is made (temporarily) integral with the container element 12 itself. Said implementation tool comprises elements which underline the direction and orientation of the three measurement axes x, y, z of the two accelerometers 2a, 2b comprised in the accelerometric sensor 1, and a compass with the relative centering (for example comprising “screw” elements) and leveling elements of the compass itself. Using the data regarding the “verticality” of the accelerometric sensor 1, with reference to axis z along which the gravity acceleration operates, and by using the data provided by said compass, the orientation of the implemented accelerometric sensor 1 itself is obtained.

It is noted that, whatever the position in which the accelerometric sensor 1 has been installed, it is possible, by detecting the angle (from the vertical) of the measurement axis z and by detecting the directions and orientations of the measurement axes x and y lying on a plane perpendicular to axis z, to identify the orientation of the measurement axes x, y, z themselves. It is noted that the “vertical” direction is identified by reading the gravity acceleration which, as is known, has a vertical direction; it is also noted that the direction and orientation of axes x and y is identified with respect to the magnetic north (the direction of the compass needle included in the above implementation tool). Which axes x′ and y′ are with respect to which the acceleration components are to be known are known on the basis of the (design) drawings related to the structure at which the above accelerometric sensor 1 has been installed, it being understood that axis z′, with respect to which the vertical acceleration component is to be known, is always the “vertical” axis (which coincides with the gravity acceleration direction).

Once the orientation of the implemented accelerometric sensor 1 is known and thereby, once the actual directions of the measurement axes x, y, z of the accelerometric sensor 1 are known (with respect to the vertical and to the magnetic north), parameters are communicated to the accelerometric sensor 1, via the acquisition unit 13 to which the accelerometric sensor 1 itself is connected, such that the accelerometric sensor 1, in operation, directly provides the values of the acceleration components according to the predetermined axes x′, y′, z′.

The considerable advantage resulting from being able to implement (always with the greatest possible care) the accelerometric sensor 1 without necessarily having to place in the “strictly exact position”, is clear. In fact, according to the above description, the actual position of the accelerometric sensor 1 is detected once it has been positioned and is “automatically corrected”, once the actual orientation of the accelerometric sensor 1 itself and the directions and orientations of the (orthogonal Cartesian) axes with respect to which the acceleration is to be measured are known. Within the container element 12, a synthetic bi-component resin is present which incorporates all the components present inside the container element 12 itself, so as to achieve a single “solid” element. Such a synthetic resin fills the entire volume that remained free inside the container element 12 once the components constituting the accelerometric sensor 1 have been installed within the container element 12 itself. According to a possible embodiment variant of the above processing of data from the accelerometric sensor 1 relating to the calculation of the acceleration components measured along axes x′, y′, z′ rather than along the measurement axes x, y, z, it can be carried out by the acquisition unit 13.

According to another possible embodiment variant, not shown in the figures, the accelerometric sensor 1 may also be provided with one or more orientation sensors functioning as a “compass”. In this way, using the data regarding the “verticality” of the accelerometric sensor 1 [(with reference to axis z (axis along which the gravity acceleration operates)], and the data provided by said one or more orientation sensors, the orientation of the implemented accelerometric sensor 1 itself can be obtained.

The container element 12 has features such as to prevent dusts and (at least) humidity from damaging the internal components of the container element 12 itself. In the case shown, the container element 12 has a dust and water protection degree identified by the initials IP67, which corresponds to an element completely protected against dust, and also protected against an (accidental) temporary immersion in water.

An accelerometric sensor, obtained according to the present invention (such accelerometric sensor is technically equivalent to the accelerometric sensor 1) may be such that the main microprocessor takes under consideration and processes the measurements carried out by the two accelerometers (or, in general, by all the accelerometers) included in the above accelerometric sensor in order to improve the accuracy of the measurements. In this case, therefore, a sort of “average” measurement is identified and both two accelerometers contribute to the identification of the acceleration measurement.

It is noted that, according to a possible embodiment variant, a sampling frequency of the signals of accelerometers 2a, 2b may be implemented which is higher than the frequency with which the accelerometric sensor 1 transmits data to the acquisition unit 13. In this case, therefore, a greater number of measurements than the number of measurements which is then transmitted to said acquisition units 13 is carried out “internally” to the accelerometric sensor 1. Each of the measurements transmitted by the accelerometric sensor 1 to the acquisition unit 13 is obtained as the “average” of a plurality of measurements or in any case is obtained by processing (for example with suitable mathematical and statistical criteria) such plurality of measurements. At least conceptually, this allows obtaining more precise measurements. This possibility results from the performance of the main microprocessor 7 which is able to implement an effective and fast processing of the data coming from the two accelerometers 2a, 2b.

Below are some comments regarding the accelerometric sensors obtained according to the present invention.

In the description, reference is made to accelerometric sensors obtained according to the present invention, in which two accelerometers are present; it is noted that it is still possible to implement an accelerometric sensor obtained according to the present invention in which there is only one accelerometer, or also in which there are more than two accelerometers.

It is noted that an accelerometric sensor according to the present invention transmits digital data to the acquisition unit to which it is connected.

The use of digital data instead of analog signals for the communication between the accelerometric sensor and the relative acquisition unit allows increasing the length of the cables connecting the accelerometric sensor to said acquisition unit (and possibly to other accelerometric sensors forming part of the above seismic monitoring system), considering that the electric background noise, which increases with the length of the cable, disturbs the digital data much less than the analog signals.

It should also be noted that the reliability of an accelerometric sensor according to the present invention is usually considerable; this depends on the factors set out hereinafter.

The accelerometric sensor is provided with a main microprocessor which, inter alia, “manages” the use of the one or more accelerometers present and controls the functioning of the above one or more accelerometers and, in general, also of other components of the accelerometric sensor; this main microprocessor then controls, with predetermined frequency, the status of the software residing in the accelerometric sensor itself and, if it is corrupted, sends an error message to the acquisition unit (to which the accelerometric sensor is connected).

In addition to using accelerometers which are only limitingly affected by the effects of the temperature at which they operate, the accelerometric sensor according to the present invention comprises a temperature sensor which, by indicating (instant by instant) the temperature at which the accelerometers operate, allows the main microprocessor to correct the measurements of the accelerometers as a function of the calibration curves of the accelerometric sensor itself. These calibration curves are included in the software that manages the main microprocessor (included in the accelerometric sensor).

In addition, the main microprocessor, which manages the components of the accelerometric sensor and the transmissions with the acquisition unit, is controlled by a control microprocessor which communicates with the main microprocessor itself by exchanging data with it. The correct data transmission between the main microprocessor and the control microprocessor is a proof of the correct functioning of both the main microprocessor and the control microprocessor.

Accelerometric sensors obtained according to the present invention can be advantageously installed at significant points of the structure to be monitored, in order to measure the accelerations of the above points. These acceleration sensors, connected to an acquisition unit, continuously measure (according to a predetermined frequency), at the instants specified by the above acquisition unit, the accelerations of the points of the structure in which they are positioned and continuously, in real time, transmit the measurements made to the acquisition unit. If the above structure undergoes a seismic event, by knowing such accelerations and the measurement times and processing such data, it is possible to calculate the displacements of the above significant points of the structure. From the values of these displacements it is possible to identify some important features of the response of the structure itself to the seismic event.

An advantage of the acceleration sensor according to the present invention consists in that it is provided with the possibility to calculate, and thus provide the values of the accelerations referred to three orthogonal axes (x′, y′, z′) not coinciding with the measurement axes (x, y, z) of the accelerometers. Such a feature allows substantially simplifying the installation steps of the accelerometric sensor at the structure to be monitored, not having to obtain, during the positioning of the accelerometric sensor itself, a geometric correspondence between the measurement axes of the accelerometers and the axes with respect to which the acceleration components are to be measured.

Another advantage of the accelerometric sensor according to the present invention consists in that it can be connected to other accelerometric sensors according to a “serial” layout; in this case, several accelerometric sensors are all connected to a single CAN bus line connecting them to the acquisition unit. In practice, “star” or “mixed” star—serial connection layouts are also possible. This freedom in configuring the connection network allows achieving optimizations and savings also in relation to the quantity and length of cables required for the operation of the seismic monitoring system of which the acceleration sensor considered is part.

A further advantage of the accelerometric sensor according to the present invention consists in that a CAN bus network (or even simply a CAN bus line) is used for the connections between the accelerometric sensors and the acquisition unit which, as its feature, has that of being also able to work in very noisy environments such as, for example, those related to industrial buildings. Moreover, the CAN bus network allows simplifying the wiring of the accelerometric sensor and, more in general, of the seismic monitoring system.

A further advantage of the accelerometric sensor according to the present invention consists in that the connection between the accelerometric sensors and the acquisition unit also includes a specific data transmission line for the synchronization of all the accelerometric sensors.

Therefore, the above acquisition unit synchronizes the measurements of all the above accelerometric sensors, indicating to them the instants at which they must carry out the acceleration measurements. This synchronization is essential in a seismic monitoring system that wants to detect the values of the relative displacements between horizontal elements.

It is noted that, if the seismic monitoring system comprises two or more acquisition units, only one of these acquisition units (the master acquisition unit) has the clock generator function for all the accelerometric sensors present in said seismic monitoring system.

It is noted that in a structure made of beams and pillars, in order to detect the state of the structure and in particular that of the pillars after a seismic event, it is essential to know the displacements of the horizontal elements during the seismic event; these displacements are obtained by means of a dual integration in the time domain of the time histories of the accelerations measured by the accelerometric sensors placed at the horizontal elements themselves (it is assumed that at least two triaxial accelerometric sensors are installed at each horizontal element).

Knowing the displacements of the horizontal elements, the relative displacements between the lower end and the upper end of each pillar comprised between two horizontal elements, and thereby the drift of the pillars, are calculated. As is known, knowing the maximum drift of a pillar during the seismic event is a very important fact to detect the state of damage of the pillar itself and thus also the state of damage of the structure.

From the above, considering the importance of the value of the difference of the relative displacements between two horizontal elements for determining the strain and deformation of the pillars comprised between the two horizontal elements, the need for these values to depend on synchronized and thus (substantially) “concurrent” acceleration measurements is clear.

1. An accelerometric sensor for seismic monitoring of structures, to be installed at a structure of a building, comprising:
one or more accelerometers;
a main microprocessor;
a control microprocessor;
a temperature sensor;
a CAN bus driver;
two connectors, one input and one output, of a CAN bus line;
an input clock circuit;
an error signaling circuit;
a power supply unit;
a container element, which at its interior contains the above-reported components;
the two accelerometers, the temperature sensor, the input clock circuit and the CAN bus driver are connected to the main microprocessor;
the control microprocessor is connected to the main microprocessor and to the error signaling circuit;
the power supply unit is connected to said components, to which it provides the necessary electric power;
the main microprocessor, in a generic time interval, considers the analog signals transmitted by at least one of the one or more accelerometers; the main microprocessor samples said analog signals with a predetermined frequency, in the instants indicated by an acquisition unit connected to said accelerometric sensor, and converts them into digital data; the main microprocessor, in addition, processes such digital data; said processing of the digital data, carried out by the main microprocessor, also comprises the correction of the measurements of the one or more accelerometers as a function of the temperature of the accelerometric sensor upon measurement; the main microprocessor then sends such data to the acquisition unit by a CAN bus network, by the CAN bus driver.

2. The accelerometric sensor according to claim 1, wherein the main microprocessor and the control microprocessor exchange signals for mutually controlling the reaction times and modes both of the main microprocessor and of the control microprocessor; if some irregularity is verified in the (data) signals exchanged between the main microprocessor and the control microprocessor, said main microprocessor and/or said control microprocessor no longer function correctly; consequently, the error signaling circuit transmits, to the acquisition unit, an out-of-service message for said accelerometric sensor.

3. Accelerometric sensor according to claim 1, wherein it comprises two accelerometers which are equivalent to each other and carry out different and interchangeable roles; one of said two accelerometers is identified as the reference accelerometer and it is therefore the accelerometer whose measurements must be considered, processed and transmitted by the main microprocessor to the acquisition unit connected to said accelerometric sensor; the other of said two accelerometers is identified as the reserve accelerometer; in case of malfunctioning of the reference accelerometer, the main microprocessor, which controls with predetermined frequency the functioning of said reference accelerometer, disconnects said reference accelerometer, signaling its malfunctioning to the acquisition unit and connects the reserve accelerometer which now begins to perform the role of reference accelerometer.

4. The accelerometric sensor according to claim 1, wherein each of the one or more accelerometers comprised in said accelerometric sensor is provided with an internal control micro-vibrator; the main microprocessor, in order to control the correct functioning of each of said one or more accelerometers, periodically activates the internal control micro-vibrator of each of the one or more accelerometers and compares the value of the acceleration, due to said micro-vibrator, measured by said accelerometer, with the exact value (known before hand) of the acceleration induced by said micro-vibrator.

5. The accelerometric sensor according to claim 1, wherein the main microprocessor comprised in the aforesaid accelerometric sensor takes under consideration and processes the measurements carried out by the two or more accelerometers comprised in said accelerometric sensor, in order to improve the precision of the measurements.

6. The accelerometric sensor according to claim 11, wherein it is connected to the acquisition unit, as well as possibly to other accelerometric sensors, by data transmission lines which comprise the CAN bus line for the transmission of the data measured by said accelerometric sensor, a synchronization line which is a specific line by which the instants are indicated, by said acquisition unit, in which said accelerometric sensor must carry out the acceleration measurements and an error signal transmission line which is a specific line for the transmission of the malfunctioning messages; said accelerometric sensor is connected to the acquisition unit also by an electrical line by which said acquisition unit power supplies said accelerometric sensor.

7. The accelerometric sensor according to claim 1, wherein it measures the acceleration providing the three components of the acceleration according to a predetermined coordinate system of orthogonal Cartesian axes x′, y′, z′ different from the coordinate system of orthogonal Cartesian axes x, y, z along which one or more accelerometers comprised therein measure said acceleration; the parameters which allow the accelerometric sensor to carry out the measurement of the accelerations with respect to the coordinate system of orthogonal Cartesian axes x′, y′, z′ are established, at the time of installation of the seismic monitoring system which includes said accelerometric sensor, during the operations of setting said accelerometric sensor, once the orientation of said implemented accelerometric sensor has been detected.

8. The accelerometric sensor according to claim 1, wherein the container element is provided with seats and/or references for the temporary coupling with an implementation tool that is made (temporarily) integral with said container element; said implementation tool comprises elements which underline the direction and orientation of the three measurement axes x, y, z of the one or more accelerometers comprised in said accelerometric sensor, and a compass; using the data regarding the verticality of the accelerometric sensor, with reference to the axis z along which the gravity acceleration operates, and by using the data provided by said compass, the orientation of said implemented accelerometric sensor is obtained.

9. The accelerometric sensor according to claim 1, wherein it also comprises one or more orientation sensors; by using the data regarding the verticality of the accelerometric sensor, with reference to the axis z along which the gravity acceleration operates, and the data provided by said one or more orientation sensors, the orientation of said implemented accelerometric sensor is obtained.

10. The accelerometric sensor according to claim 1, wherein within the container element, a synthetic resin is present which incorporates all the components present inside the container element itself, so as to achieve a single solid element; said synthetic resin fills the entire volume that remained free inside said container element once the components constituting said accelerometric sensor have been installed within said container element.
